(19) United States
(12) Patent Application Publication
(10) Pub. No.: US 2011/0308025 A1
(43) Pub. Date: Dec. 22, 2011

(54) ROTATING CLEANING DEVICE

(75) Inventors: Peter S. Vosbikian, Moorestown, NJ (US); Vince Cella, Medford, NJ (US)

(73) Assignee: QUICKIE MANUFACTURING CORPORATION, Cinnaminson, NJ (US)

(21) Appl. No.: 13/221,320

(22) Filed: Aug. 30, 2011

Related U.S. Application Data
(63) Continuation-in-part of application No. 12/700,041, filed on Feb. 4, 2010.
Application No. 12/700,041 is a continuation of application No. 11/361,205, filed on Feb. 24, 2006.

(51) Int. Cl. B08B 7/00; A47L 13/00; A47L 13/10

(52) U.S. Cl. 15/105; 15/115; 15/106; 15/111

(57) ABSTRACT

A cleaning implement comprising a base member having opposing top and bottom surfaces and at least one side surface. A handle is connected to the top surface of the base member and a first cleaning material is attached to the bottom surface of the base member. A cleaning member is rotatably connected to the at least one side surface of the base member and a second cleaning material attached to the cleaning member such that the second cleaning material is oriented in a different plane than the first cleaning material.

### CROSS REFERENCE TO RELATED APPLICATIONS

This application is a continuation-in-part of U.S. patent application Ser. No. 12/700,041, filed Feb. 4, 2010, which is a continuation of U.S. patent application Ser. No. 11/361,205, filed Feb. 24, 2006.

### BACKGROUND

Conventional cleaning devices, such as brushes, brooms, scrubbers, mops, and sponges, often lack the ability to reach differing oriented surfaces as a result of their cleaning material being oriented in a fixed configuration.

A cleaning device, and method for its use, is needed which will allow a user to orient the cleaning material of the cleaning device into differing configurations in order to clean variably oriented surfaces.

### SUMMARY

In one embodiment, a cleaning implement comprises a base member, a first cleaning material attached to the base member, a cleaning member rotatably connected to the base member, and a second cleaning material attached to the cleaning member. The second cleaning material is oriented in a different plane than the first cleaning material.

In another embodiment, a cleaning implement comprises a handle, a base member connected to the handle, a first cleaning material attached to the base member, a cleaning member rotatably attached to the base member, two or more receiving surfaces defined in the base member, and a second cleaning material attached to the cleaning member. The cleaning member is adapted to rotate relative to the base member for positioning the cleaning member into two or more cleaning positions relative to the base member.

In another embodiment, a cleaning implement comprises a base member having opposing top and bottom surfaces and at least one side surface. A handle is connected to the top surface of the base member and a first cleaning material is attached to the bottom surface of the base member. A cleaning member is rotatably connected to the at least one side surface of the base member and a second cleaning material attached to the cleaning member such that the second cleaning material is oriented in a different plane than the first cleaning material.

In another embodiment, a cleaning implement comprises a base member having opposing top and bottom surfaces and at least one side surface. A handle is connected to the top surface of the base member and a first cleaning material attached to the bottom surface of the base member. A cleaning member is rotatably attached to the at least one side surface of the base member and two or more receiving surfaces defined in the at least one side surface of the base member. The two or more receiving surfaces are configured to receive the cleaning member and position the cleaning member into at least two distinct cleaning positions. A second cleaning material is attached to the cleaning member such that the cleaning member is adapted to rotate relative to the base member for positioning the cleaning member into distinct cleaning positions relative to the base member.

In another embodiment, a method of cleaning utilizing a cleaning implement comprises the steps of providing a cleaning implement including a base member, a first cleaning material attached to the base member, a cleaning member connected to the base member, and a second cleaning material attached to the cleaning member. The cleaning member is oriented into a first cleaning position relative to the base member, and then rotated into a second fixed cleaning position relative to the base member.

In another embodiment, a method of cleaning utilizing a cleaning implement comprises providing a cleaning implement including a base member having opposing top and bottom surfaces and at least one side surface, a handle connected to the top surface of the base member, a first cleaning material attached to the bottom surface of the base member, a cleaning member rotatably connected to the at least one side surface of the base member, and a second cleaning material attached to the cleaning member. The cleaning member is oriented into a first cleaning position relative to the base member and is rotated into a second cleaning position relative to the base member.

### BRIEF DESCRIPTION OF THE DRAWINGS

FIG. 1 is a frontal perspective view of one embodiment of a cleaning implement with the rotatable cleaning member in a horizontal position along the base member;

FIG. 2 is a frontal perspective view of the base member of FIG. 1;

FIG. 3 is a frontal perspective view of the rotatable cleaning member of FIG. 1;

FIG. 3A is a back plan view of the cleaning member of FIG. 1;

FIG. 3B is a bottom plan view of the cleaning member of FIG. 1;

FIG. 3C is a partial cross-sectional view of the cleaning member of FIG. 3B along line 3C-3C;

FIG. 4 is a partial cross-sectional view of the cleaning implement of FIG. 1 along line 4-4 showing a cross-section of the cleaning member and base member;

FIG. 5 is a top perspective view of the cleaning implement of FIG. 1 with the rotatable cleaning member being partially removed from the base member in order to compress the spring and rotate the cleaning member into a vertical position along the base member;

FIG. 6 is a frontal perspective view of the cleaning implement of FIG. 1 with the rotatable cleaning member in a vertical position along the base member;

FIG. 7A is a frontal perspective view of the base member of a second embodiment of a cleaning implement according to the invention;

FIG. 7B is a frontal elevation view of the base member of FIG. 7A;

FIG. 8A is a frontal perspective view of a rotatable cleaning member according to the second embodiment of a cleaning implement according to the invention, which cleaning member is adapted for cooperation with the base member of FIGS. 7A and 7B;

FIG. 8B is a rear perspective view of the rotatable cleaning member of FIG. 8A; and

FIG. 8C is a rear elevation view of the rotatable cleaning member of FIG. 8A.

### DETAILED DESCRIPTION

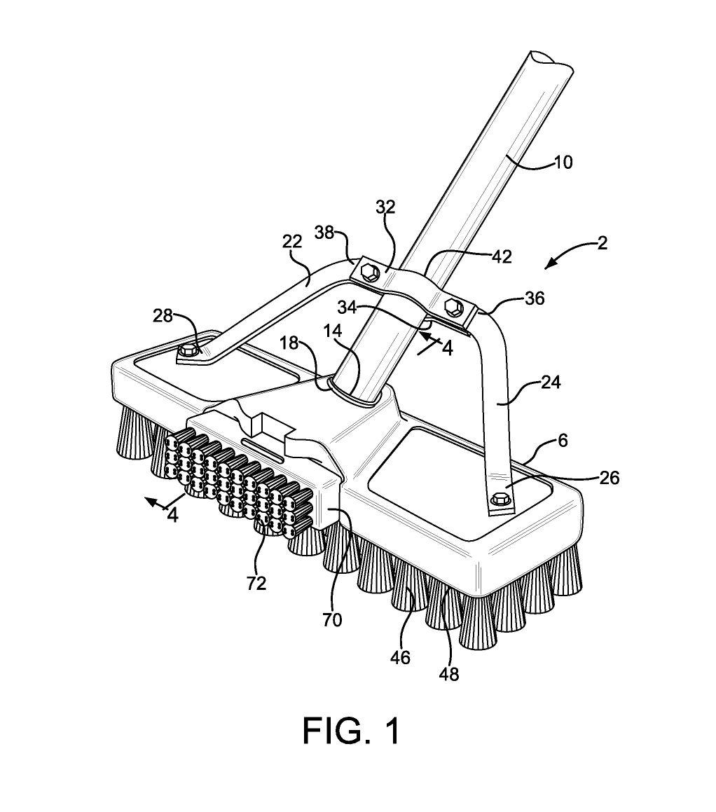

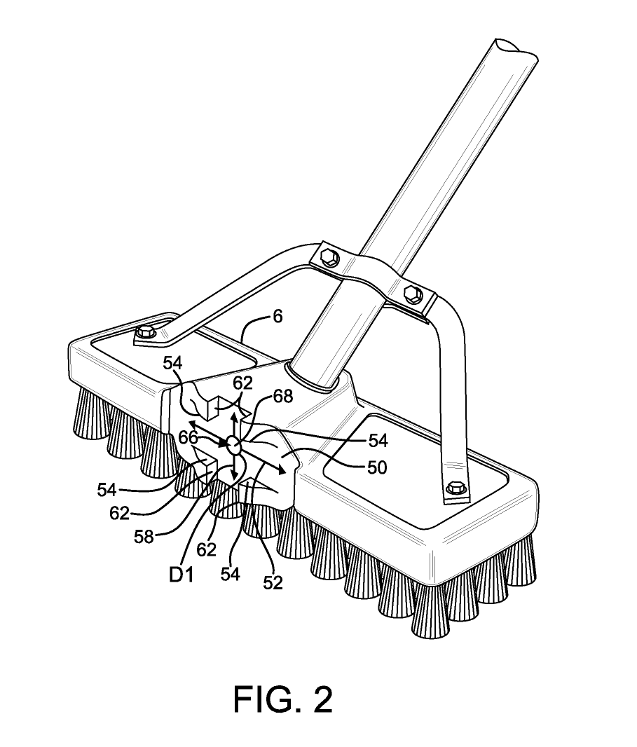

FIG. 1 depicts one embodiment of a cleaning implement. Cleaning implement 2 comprises a base member 6 and handle 10. The base member 6 is made of foam filed Polypropylene while the handle 10 is made of wood. In other embodiments, the base member 6 and handle 10 may be made of any material known in the art, such as any type of wood, plastic, or metal. As shown in FIGS. 1 and 2, the base member 6 is substantially rectangular, but in other embodiments may be in any shape known in the art.

The handle 10 is secured to the base member 6 as a result of an end 14 of the handle 10 being threaded into a hole 18 in the base member 6. In other embodiments, the handle 10 may be connected to the base member 6 by any mechanism known in the art, such as through the utilization of bolts or snap-fits. Stabilizing arms 22 and 24 extend from the handle 10 to the base member 6 to assist in stabilizing the connection of the handle 10 to the base member 6. Ends 26 and 28 of the stabilizing arms 22 and 24 are bolted to the base member 6. Metal connection members 32 and 34 run between, and are bolted to, the other ends 36 and 38 of the stabilizing arms 22 and 24. The handle 10 extends through a substantially circular aperture 42 formed between the connection members 32 and 34. In other embodiments, other mechanisms known in the art may be used to stabilize the connection between the handle 10 and the base member 6.

Bristles 46 extend substantially perpendicularly from a bottom surface 48 of the base member 6. The bristles 46 are made of Polypropylene. In other embodiments, the bristles 46 may be made of any material and in any configuration known by those skilled in the art. In still other embodiments, instead of having bristles 46 for use as a brush, scrubber, or broom, the base member 6 may comprise a mop head, sponge head, or other type of head known in the art, having strands or other material, emanating from the base member 6 made for mopping, sponge usage, or other usage known in the art. In additional embodiments, the base member 6 itself may not have any capacity for acting as a brush, scrubber, broom, mop, or sponge, but instead may be connected to a member having such capacity.

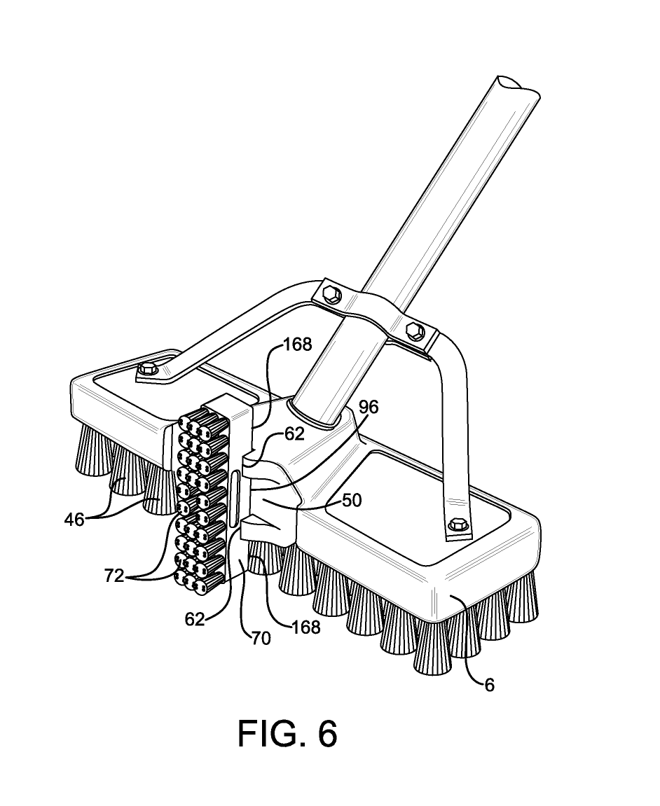

FIGS. 1-6 reveal a first embodiment of cooperating means carried by the base member and a cleaning member (discussed below) for releasably retaining the cleaning member in at least two positions relative to the base member. More particularly, a front surface 50 of the base member 5 contains a horizontal pathway 52 cut into the front surface 50. The horizontal pathway 52 is partially surrounded by ridges 54. A vertical pathway 58 is also cut into the front surface 50 of the base member 6. Abutments 62 partially line the vertical pathway 58. In a location 66 where the horizontal pathway 52 and vertical pathway 58 intersect, a hole 68 of diameter D1, used for the attachment of a cleaning member 70, extends from the front surface 50 partially into the cross-section of the base member 6. The horizontal and vertical pathways 52 and 58 are configured to accommodate attachment of the cleaning member 70 to allow the cleaning member 70 to be held in both a horizontal position, as shown in FIG. 1, and a vertical position, as shown in FIG. 6. In such manner, the cleaning member 70 may be utilized to clean surfaces in planes other than the plane of the surface oriented directly under the brush member. In other embodiments, one or more pathways along any surface of the base member 6, in any type of configuration, may be utilized to hold the cleaning member 70 in any desired position.

In still other embodiments, the base member 6 may comprise two or more receiving surfaces, in any location or configuration, which are adapted to receive the cleaning member 70 against the receiving surfaces. The receiving surfaces may comprise any type of arrangement adapted to receive the cleaning member 70, such as a portion of a male and female arrangement, a portion of a slot and groove arrangement, and a portion of a ball and socket arrangement The receiving surfaces may be utilized to receive the cleaning member 70 in a multitude of different orientations and positions, such as horizontal, vertical, and angular. The receiving surfaces may also be adapted to restrain the cleaning member 70 in one or more directions when the cleaning member 70 is against the receiving surfaces.

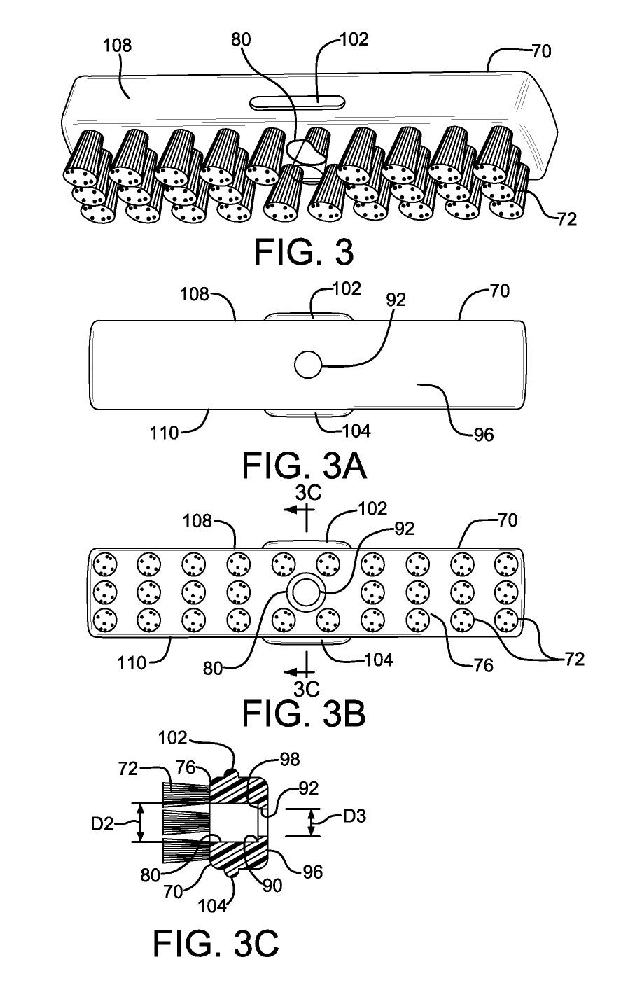

FIGS. 3, 3A, 3B, and 3C depict various views of the cleaning member 70. The cleaning member 70 is made of foam filled Polypropylene and is substantially rectangular. In other embodiments, the cleaning member 70 may be made of any material known in the art and may be in any configuration. Polypropylene bristles 72 extend substantially perpendicularly from a front surface 76 of the cleaning member 70. In other embodiments, the bristles 72 may he made of any known material and in any location or configuration. The bristles 72 may be used to sweep, scrub, or brush during cleaning. In still other embodiments, the cleaning member 70 may comprise a sponge head or other type of cleaning head having material emanating from the cleaning member 70 made for sponge or other cleaning usage.

As shown best by FIG. 3C, which is a partial cross-sectional view of the cleaning member 70 taken along line 3C-3C of FIG. 3B, a substantially circular aperture 80 of diameter D2 extends from the front surface 76 of the cleaning member 70 partially through the cross-section of the cleaning member 70. At the location 90 in the cross-section where the aperture 80 ends, a substantially circular aperture 92, of smaller diameter D3 than the diameter D2 of the aperture 80, extends through the remaining cross-section and through the back surface 96 of the cleaning member 70. In such manner, a shoulder 98 is formed within the cross-section of the cleaning member 70. Gripping members 102 and 104 extend from side surfaces 108 and 110 of the cleaning member 70. In other embodiments, the cleaning member 70 may utilize one or more apertures or gripping members in any location, size, alignment, or configuration.

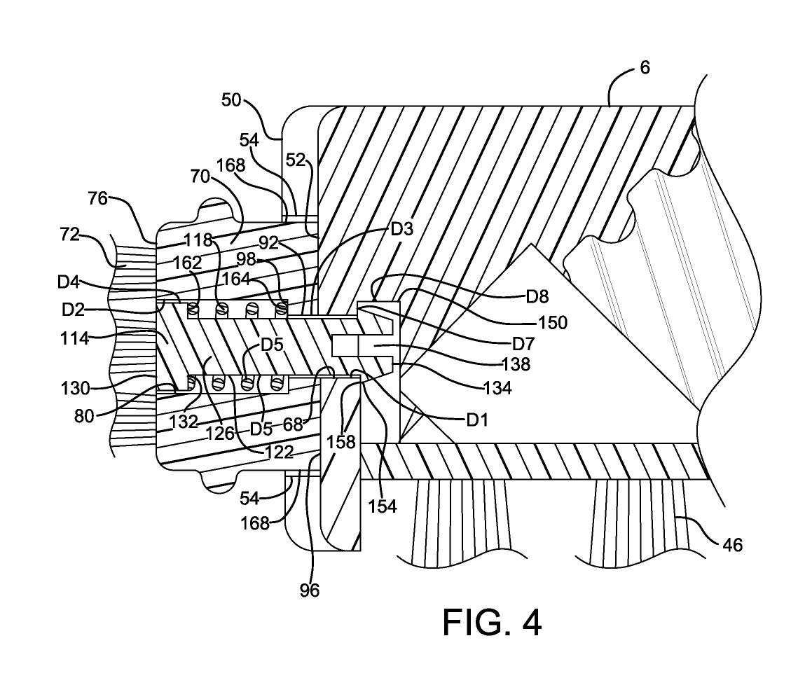

FIG. 4 shows a partial cross-sectional view taken along line 4-4 of FIG. 1 to demonstrate the attachment of the cleaning member 70 to the base member 6 in a horizontal position as a result of the horizontal pathway 52. To attach the cleaning member 70 to the base member 6, a nylon pin member 114, having a steel spring 118 extending around an inner portion 122 of the nylon pin member's shaft 126, is inserted into the substantially circular aperture 80 in the front surface 76 or the clearing member 70. In other embodiments, the pin member 114 and spring 118 may be of differing material, shapes, sizes, locations, and configurations. In further embodiments, other mechanisms may be utilized to attach the cleaning member 70 to the base member 6.

The nylon pin member 114 has an end portion 130 of smaller diameter D4 than the diameter D2 of the aperture 80 in the front surface 76 of the cleaning member 70 to allow insertion into the cleaning member 70. At the same time, the diameter D4 of the end portion 130 of the nylon pin member 114 is larger than the diameter D3 of the aperture 92 in the back surface 96 of the cleaning member 70 to prevent the end portion 130 of the nylon pin member 114 from passing through the aperture 92 in the cleaning member 70.

The inner portion 122 of the nylon pin member's shaft 126 has a diameter D5 which is smaller than both the diameter D4 of the end portion 130 of the nylon pin member 114, and the diameter D3 of the aperture 92 in the back surface 96 of the cleaning member 70. Due to the diameter differences, the inner portion 122 of the nylon pin member's shaft 126 is allowed to pass at least partially through both of the apertures 80 and 92 of the cleaning member 70. The diameter D6 of the spring 118, when it is extended around the inner portion 122 of the nylon pin members shaft 126, is larger than the inner portion's diameter D5. The spring 118 is held between the shoulder 132 of the end portion 130 of the nylon pin member 114 and the shoulder 98 of the cleaning member 70.

An end 134 of the pin member 114 has a cut-out section 138 in its cross section to allow the pin member's end 134 to be compressed during insertion of the pin member 114 into the hole 68 of the base member 6. The diameter D7 of the end 134 of the pin member 114 is larger than the diameter D1 of the hole 68 in the base member 6, but smaller than the diameter D8 of a secondary hole 150 extending within the cross-section of the base member 6.

When the pin member 114 is inserted into the aperture 80 in the front surface 76 of the cleaning member 70, the end 134 of the pin member 114 is passed out of the aperture 92 in the back surface 96 of the cleaning member 70 and through the hole 68 in the base member 6. Due to the end 134 of the pin member 114 having a larger diameter D7 than the diameter D1 of the hole 68 or the base member 6, the end 134 of the pin member 114 is compressed as it passes through the hole 68 in the base member 6. As the end 134 of the pin member 114 reaches the secondary hole 150 in the cross-section of the base member 6, the end 134 of the pin member 114 expands outwardly due to the increased diameter D8 of the secondary hole 150. At that point, a shoulder 154 of the pin member's end portion 134 abuts against a shoulder 158 within the cross-section of the base member 6 to lock the pin member 114 in place, thereby preventing the pin member 114 from slipping out of the hole 68 in the base member 6. As a result, since the diameter D4 of the end portion 130 of the nylon pin member 114 is larger than the diameter D3 of the aperture 92 in the back surface 96 of the cleaning member 70, thereby preventing the end portion 130 of the nylon pin member 114 from passing through the aperture 92 in the cleaning member 70, the cleaning member 70 is securely attached to the base member 6.

The spring's 118 naturally extended state forces the spring ends 162 and 164 to press respectively against the shoulder 132 of the end portion 130 of the nylon pin member 114 and the shoulder 98 of the cleaning member 70. In such manner, the back surface 96 of the cleaning member 70 is fixedly secured within the horizontal pathway 52 in the front surface 50 of the base member 6, with surfaces 168 of the cleaning member 70 abutted against ridges 54 in the front surface 50 of the base member 6 thereby preventing movement. As a result, as shown in FIGS. 1 and 4, the cleaning member 70 is locked in a horizontal position against the base member 6. In other embodiments, the spring 118 may be utilized to apply a force to the cleaning member 70 towards at least one of two or more receiving surfaces defined in the base member 6. In further embodiments, other mechanisms may be used in place of the spring 118 and pin member 114 to lock the cleaning member 70 in place against the base member 6.

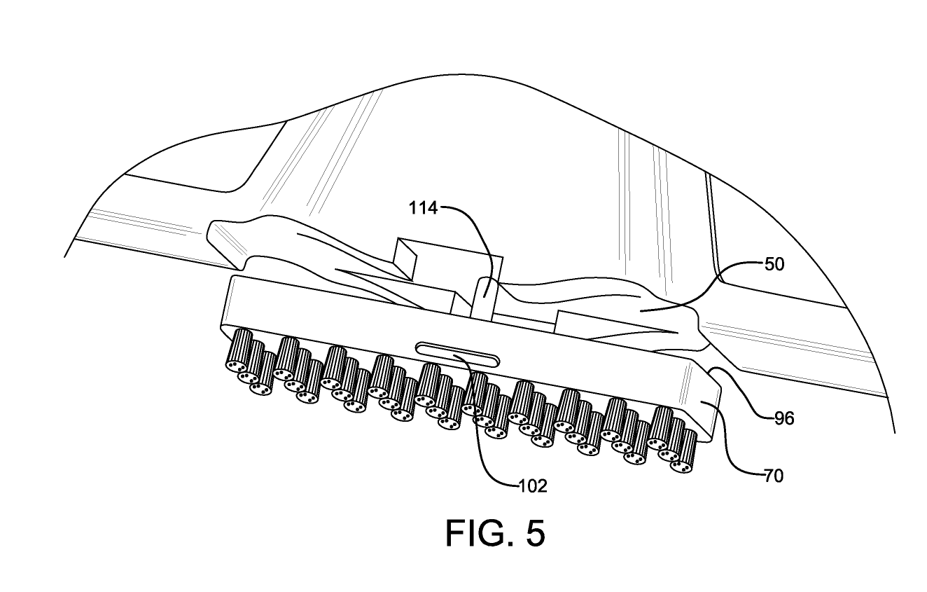

As shown in FIG. 5, to change the position of the cleaning member 70 from the horizontal position of FIG. 1 to the vertical position of FIG. 6, a user grasps one or more of the gripping members 102 and 104 to pull the back surface 96 of the cleaning member 70 away from the front surface 50 of the base member 6. During this process, as can be visualized using FIG. 4, the shoulder 132 of the end portion 130 of the pin member 114 interferes with the shoulder 98 of the cleaning member 70 thereby preventing the cleaning member 70 from slipping off the pin member 114. While this occurs, the spring 118 is compressed between the shoulder 98 of the cleaning member 70 and the shoulder 132 of the end portion 130 of the nylon pin member 114.

The user then rotates the cleaning member 70 into the vertical position of FIG. 6 and releases the cleaning member 70. As visualized using FIGS. 2, 4, and 6, the spring 118 re-extends into its natural state forcing the cleaning member 70 to be aligned within the vertical pathway 58 in the front surface 50 of the base member 6. In such manner, the back surface 96 of the cleaning member 70 is fixedly secured within the vertical pathway 58 in the front surface 50 of the base member 6, with surfaces 168 of the cleaning member 70 aligned against abutments 62 in the front surface 50 of the base member 6 to prevent movement. As a result, the cleaning member 70 is locked in a vertical position against the base member 6. In other embodiments, other mechanisms may be used in place of the spring 118 and pin member 114 to allow re-positioning of the cleaning member 70.

The rotating cleaning member 70 allows a user to clean surfaces oriented in different positions by simply re-orienting the cleaning member 70 into a different position. When the cleaning member 70 is in the horizontal position of FIG. 1, the bristles 72 of the cleaning member 70 may he used to scrub wide surfaces aligned along the front surface 50 of the base member 6. In this position, the substantially perpendicular alignment of the bristles 72 of the cleaning member 70 with respect to the bristles 46 of the base member 6 allows a user to brush, scrub, or sweep horizontal or vertical surfaces utilizing two sets of differently oriented bristles 46 and 72 in different planes.

When the cleaning member 70 is in the vertical position of FIG. 6, the bristles 72 of the cleaning member 70 may be used to brush, scrub, or sweep narrow, recessed, grooved surfaces, such as grout lines in a tile floor, which are aligned perpendicularly to the front surface 50 of the base member 6. In this position, the substantially perpendicular alignment of the bristles 72 of the cleaning member 70 with respect to the bristles 46 of the base member 6 again allows a user to brush, scrub, or sweep horizontal or vertical surfaces utilizing two sets of differently oriented bristles 46 and 72.

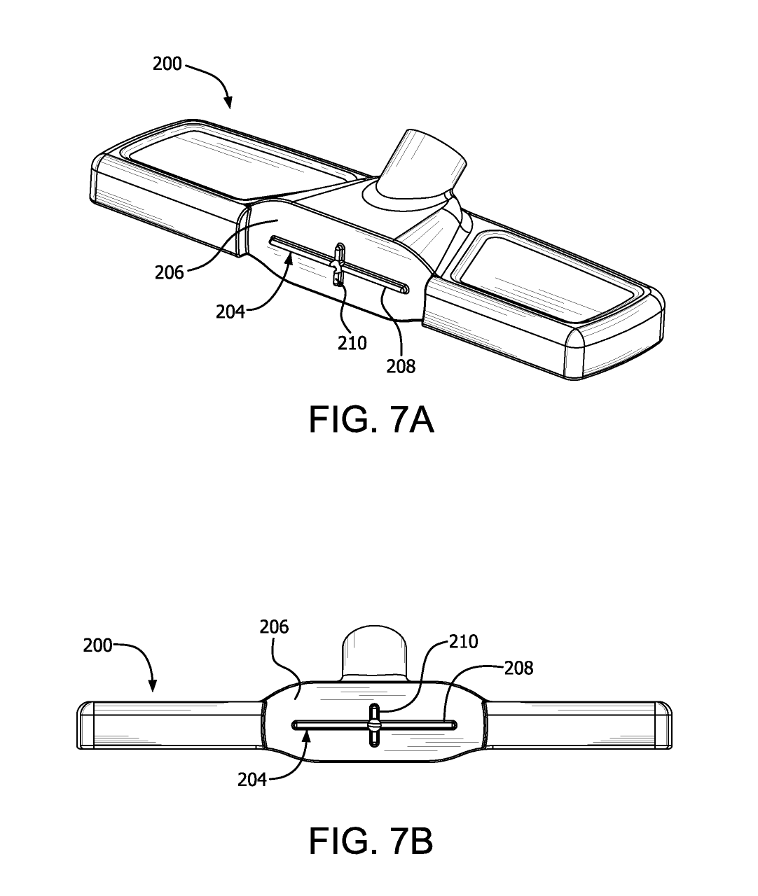

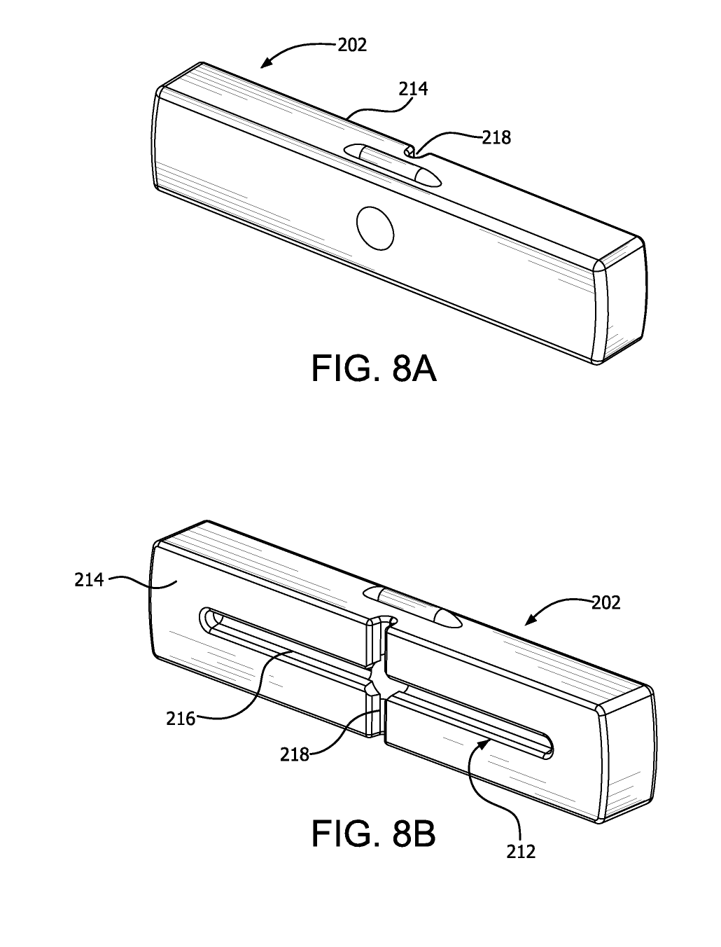

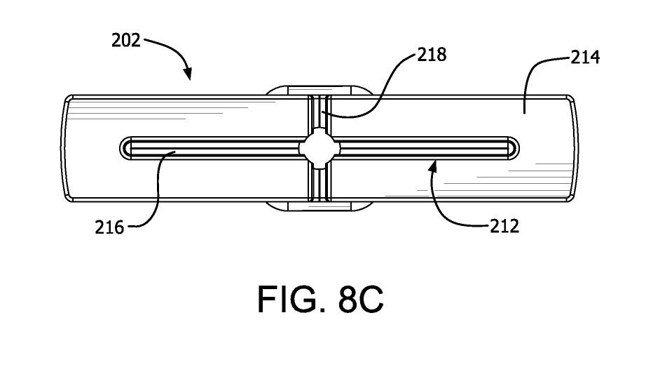

According to another other embodiment of the invention described in connection with FIGS. 7A-8C, in which the cleaning material of the rotatable cleaning member is omitted for clarity of illustration, still other cooperating means may be carried by the base member (which base member is identified generally by reference numeral 200 in FIGS. 7A and 7B) and the rotatable cleaning member (which rotatable member is identified generally by reference numeral 202 in FIGS. 8A-8C) for releasably retaining the cleaning member in at least two positions relative to the base member. In particular, as shown in FIGS. 7A and 7B, such means may include, for example, male formations or protrusions 204 provided on a front side surface 206 of base member 200. Similar to the above-described pathways 52, 58, the male formations 204 may include at least one portion that extends in a substantially horizontal direction (as indicated by reference numeral 208) and at least one portion that extends in a substantially vertical direction (as indicated by reference numeral 210) in relation to the front side surface 206 of the base member 200. It will be understood, however, that male formations 204 may be arranged at other than horizontal and vertical orientations and may extend at less than or greater than 90 degrees relative to one another.

Correspondingly, as depicted in FIGS. 8A-8C, the cooperating means according to the second embodiment of the invention further female formations or recesses 212 provided on a rear surface 214 of cleaning member 202 which are adapted to selectively and releasably receive male formations 204 provided on base member 200. Similar to the male formations 204, the female formations 212 may include at least one portion that extends in a substantially horizontal direction (as indicated by reference numeral 216) and at least one portion that extends in a substantially vertical directions (as indicated by reference numeral 218) in relation to the rear surface 214 of the cleaning member 202. It will be understood, however, that, like male formations 204, the female formations 212 may be arranged at other than substantially horizontal and vertical orientations and may extend at less than or greater than 90 degrees relative to one another. It will also be understood that the relative positions of the male and female formations 204, 212 may be reversed. That is, the female portions 212 may be carried by the base member 200 and the male portions 204 may be carried by the cleaning member 202.

Further, it will be appreciated that the cleaning member 202 according to the second embodiment may be biased toward the base member 200 by an unillustrated spring similar in construction, function and arrangement to spring 118 described hereinabove in connection with FIG. 4. So equipped, the cleaning member 202 will be securely retained relative to the base member 200 upon turning of the cleaning member into a desired position in which the corresponding male and female portions 204, 212 come into mating relationship.

Although the present invention has been described with reference to specific embodiments, those skilled in the art will recognize that changes may be made in form and detail without departing from the spirit and scope of the invention. As such, it is intended that the foregoing detailed description be regarded as illustrative rather than limiting and that the appended claims, including all equivalents thereof, are intended to define the scope of the invention.

What is claimed is:

1. A cleaning implement comprising:
a base member having opposing top and bottom surfaces and at least one side surface;
a handle connected to the top surface of the base member;
a first cleaning material attached to the bottom surface of the base member;
a cleaning member rotatably attached to the at least one side surface of the base member,
cooperating means carried by at the least one side surface of the base member and by the cleaning member for positioning the cleaning member into at least two distinct cleaning positions; and
a second cleaning material attached to the cleaning member, wherein the cleaning member is adapted to rotate relative to the base member for positioning the cleaning member into the at least two or more distinct cleaning positions relative to the base member.

2. The cleaning implement of claim 1 further comprising a spring, wherein the spring is adapted to apply force to the cleaning member toward the base member.

3. The cleaning implement of claim 1, wherein each of the first and second cleaning materials comprise at least one of bristles, brush material, mop material, sponge material, scrubber material, and broom material.

4. The cleaning implement of claim 1, wherein said cooperating means comprise male formations provided on one of the base member and the cleaning member and female formations provided on the other of the base member and the cleaning member.

5. The cleaning implement of claim 4, wherein said male formations are provided on the base member and said female formations are provided on the cleaning member.

6. The cleaning implement of claim 4, wherein said male formations are provided on the cleaning member and said female formations are provided on the base member.

7. The cleaning implement of claim 4, wherein said male and female formations include a first portion extending in a first direction and a second portion extending in a second direction different from said first direction.

8. The cleaning implement of claim 7, wherein said first and second portions are disposed substantially at a right angle with respect to one another.

9. The cleaning implement of claim 7, wherein said first portion is disposed substantially horizontally and said second portion is disposed substantially vertically.
